(19) United States
(12) Patent Application Publication
(10) Pub. No.: US 2020/0060273 A1
(43) Pub. Date: Feb. 27, 2020

(54) FUNGICIDAL COMPOSITIONS

(71) Applicant: Novus International, Inc., St. Charles, MO (US)

(72) Inventors: Matthew Mahoney, St. Charles, MO (US); Graciela B. Arhancet, St. Charles, MO (US)

(21) Appl. No.: 16/110,144

(22) Filed: Aug. 23, 2018

(51) Int. Cl. A01N 37/36; A01N 43/54; A01N 43/38; A01N 43/653; A01N 43/16; A01N 25/02; A01N 25/12

(52) U.S. Cl. CPC A01N 37/36; A01N 43/54; A01N 43/38; A01N 25/12; A01N 43/16; A01N 25/02; A01N 43/653

(57) ABSTRACT

Fungicidal compositions comprising a fungicide and an adjuvant, wherein the adjuvant increases the antifungal activity of the fungicide.

### FIELD OF THE INVENTION

The present invention relates to fungicidal compositions for the treatment or prevention of fungal infection in plants.

### BACKGROUND OF THE INVENTION

Fungicides are a category of agrochemicals used in commercial crop production to reduce pathogen levels allowing crops to grow to maturity with increased yields. Globally, fruits, vegetables, and cereal crops have been, and continue to be, the largest users of fungicides, accounting for nearly 70% of the fungicide used around the world. Over the past 30 years, governments have been setting tighter pesticide tolerances limiting the amount of pesticide residues that can lawfully remain in or on domestically produced or imported consumer-ready foods. This has been driven by a growing environmental and human health concerns as well as pressure exerted on food suppliers by consumer groups to decrease the number of sprays on crops.

A major overhaul of pesticide residue tolerances was implemented in the U.S. in 1996; significantly lowering residue levels on several active ingredients. Many chemicals have been ‘delisted’ and are prohibited from use in the US, Europe, and Asia. In response, producers are using more targeted chemical products and practice precision spraying to reduce the number and cost of sprays.

Another problem in global agriculture is fungicide resistance to currently and widely used fungicides. The loss of a fungicide to agriculture through resistance may lead to unexpected and costly crop losses to farmers causing local shortages and increased food prices. The problem of resistance has increased since the advent of highly effective compounds with specific sites of action. Although representing marked improvements in performance, including systemic and therapeutic properties, experience has shown that these compounds may be prone to resistance. As reliance on these fungicides grows, action is required to safeguard their effectiveness.

One attractive method is to increase the efficacy of a fungicide to enhance its action by use of an adjuvant. An adjuvant is a compound that is not itself an active fungicide, but which improves the activity of a pesticide, for example by improving its ability to penetrate, target, or protect the plant. Adjuvants may also modify the formulation to improve properties of the formulation including its droplet size, ability to spread and penetrate a target.

What is needed, therefore, is an adjuvant that is effective at improving the activity of a variety of fungicides.

### SUMMARY OF THE INVENTION

Among the various aspects of the present disclosure is a composition comprising a fungicide and an adjuvant chosen from a compound of Formula (I) or salt thereof, a compound of Formula (II), or a polymer comprising repeat units of Formula (III):

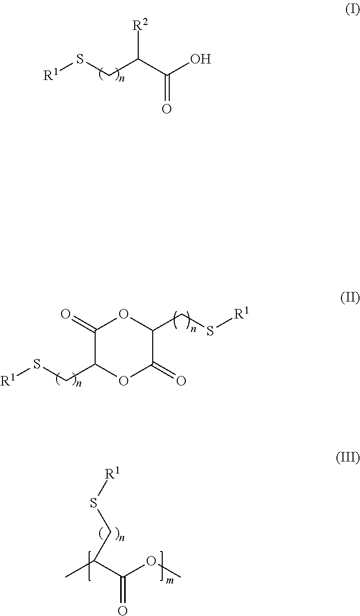

wherein:
R¹ is methyl or ethyl;
R² is hydroxyl or amino;
n is an integer of 1 or 2; and
m is an integer greater than 1;

and wherein the adjuvant is present in an amount of less than 5% by weight of the composition.

Another aspect of the present disclosure provides a method of treating or preventing a fungal infection, the method comprising applying the composition described above to a plant, a seed, or soil adjacent to the plant or the seed after planting.

Other aspects and iterations of the invention are described more thoroughly below.

### BRIEF DESCRIPTION OF THE DRAWINGS

FIG. 1A shows fungistatic activity of chitosan and/or HMTBA against Verticillium dahlia. Radial colony growth is plotted as colony diameter for Antifungal Assay Agar (AAA) plates (control) and AAA plates containing HMTBA (H), LMW chitosan (C1-C4), or LMW chitosan/HMTBA blends (C1H-C4H).

FIG. 1B compares the inhibition of V. dahlia growth of LMW chitosan (C1-C4) and LMW chitosan/HMTBA blends (C1H-C4H) presented in FIG. 1A. The left bar represents the chitosan alone and the right bar represents the chitosan/HMTBA blend.

FIG. 2A shows fungistatic activity of chitosan and/or HMTBA against Fusarium oxysporum. Radial colony growth is plotted as colony diameter for Antifungal Assay Agar (AAA) plates (control) and AAA plates containing HMTBA (H), LMW chitosan (C1-C4), or LMW chitosan/HMTBA blends (C1H-C4H).

FIG. 2B compares the inhibition of F. oxysporum growth of LMW chitosan (C1-C4) and LMW chitosan/HMTBA blends (C1H-C4H) presented in FIG. 2A. The left bar represents the chitosan alone and the right bar represents the chitosan/HMTBA blend.

FIG. 3A shows fungistatic activity of chitosan and/or HMTBA against Rhizoctonia solani. Radial colony growth is plotted as colony diameter for Antifungal Assay Agar (AAA) plates (control) and AAA plates containing HMTBA (H), LMW chitosan (C1-C4), or LMW chitosan/HMTBA blends (C1H-C4H). The white area of the bar graph represents the calculated area beyond 90 mm.

FIG. 3B compares the inhibition of R. solani growth of LMW chitosan (C1-C4) and LMW chitosan/HMTBA blends (C1H-C4H) presented in FIG. 3A. The left bar represents the chitosan alone and the right bar represents the chitosan/HMTBA blend.

FIG. 4A presents the percent disease control provided by azoxystrobin without HMTBA (left column) or with HMTBA (right column) against powdery mildew (Podosphaera xanthii).

FIG. 4B plots the percent control change for combinations of azoxystrobin and HMTBA against powdery mildew (P. xanthii). Change in control is the difference in percent control between treatments with and without HMTBA.

FIG. 5A presents the percent disease control provided by captan without HMTBA (left column) or with HMTBA (right column) against Botrytis cinerea mycelial growth.

FIG. 5B plots the percent control change for combinations of captan and HMTBA against Botrytis cinerea. Change in control is the difference in percent control between treatments with and without HMTBA.

FIG. 6A shows the average size (in cm) of Fusarium graminearum mycelial growth on metconazole infused selective media with and without HMTBA.

FIG. 6B presents the percent control of F. graminearum mycelial growth following metconazole treatment with and without HMTBA.

FIG. 6C plots the percent change in F. graminearum mycelial growth control for metconazole with the addition of HMTBA.

FIG. 7 presents the average powdery mildew severity ratings on greenhouse grown summer squash plants following the indicated treatments.

FIG. 8 shows the powdery mildew incidence on greenhouse grown summer squash plants following the indicated treatments.

FIG. 9 presents the Area Under the Disease Progress Curve for powdery mildew symptoms on greenhouse grown summer squash plants following the indicated treatments.

FIG. 10 plots the powdery mildew percent control to show disease control in contrast to the untreated check from AUDPC of severity shown in FIG. 9.

### DETAILED DESCRIPTION

The present invention provides compositions of a fungicide and an adjuvant. It has been discovered that the adjuvant can provide a number of advantages over application of the fungicide alone including increasing the efficacy of the fungicide. Importantly, the adjuvant itself is not a fungicide, and therefore is not subject to the same types of restrictions that fungicides are subject to. Furthermore, the adjuvant meets commercial needs of being non-toxic and biodegradable. In various embodiments, the adjuvant may also provide beneficial properties to the formulation such as dispersability, droplet size, pH, and film-forming properties that may increase resistance of the composition to conditions in the field.

### (I) Compositions Comprising Fungicide and Adjuvant

The disclosure provides compositions comprising a fungicide and an adjuvant chosen from a compound of Formula (I) or salt thereof, a compound of Formula (II), or a polymer comprising repeat units of Formula (III), wherein the adjuvant is present in an amount of less than 5% by weight of the composition.

(a) Adjuvants

In some embodiments, the adjuvant in the composition may be a compound of Formula (I) or a salt thereof:

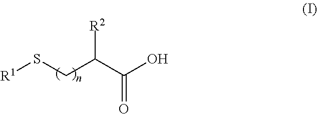

wherein:
R¹ is methyl or ethyl;
R² is hydroxyl or amino; and
n is an integer of 1 or 2.

In specific embodiments, the compound of Formula (I) is a compound of Formula (Ia):

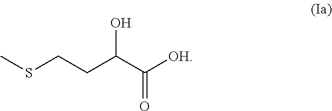

The compound of Formula (Ia) is 2-hydroxy-4(methylthio)butanoic acid (commonly known as “HMTBA” and sold by Novus International, St. Louis, Mo. under the trade name ALIMET®.

Suitable salts of the compounds of Formula (I) and Formula (Ia) include, without limit, calcium, sodium, potassium, magnesium, and lithium.

In other embodiments, the adjuvant in the composition may be a compound of Formula (II):

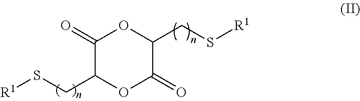

wherein:
R¹ is methyl or ethyl; and
n is an integer of 1 or 2.
   Compounds of Formula (II) are detailed in U.S. Pat. No. 9,011,832, the disclosure of which is incorporated herein by reference in its entirety.

In specific embodiments, the compound of Formula (II) is a compound of Formula (IIa):

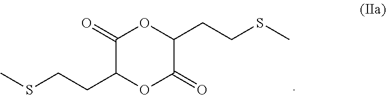

In alternate embodiments, the adjuvant in the composition may be a polymer comprising repeat units of Formula (III):

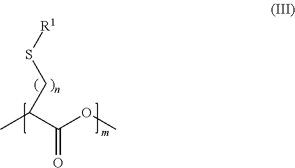

wherein:
R¹ is methyl or ethyl;
n is an integer of 1 or 2; and
m is an integer greater than 1.
   Polymers comprising repeat units of Formula (III) are described in U.S. Pat. Nos. 9,284,294 and 9,410,036, the disclosure of each is incorporated herein by reference in its entirety.

In some embodiments, the polymers may be homopolymers in which every repeat unit of Formula (III) is identical. In other embodiments, the polymers may be copolymers in which the repeat units for Formula (III) differ (i.e., are substituted differently in at least one position). Alternatively, the copolymers comprising repeat units of Formula (III) may further comprise a second type of repeat unit derived from a lactide, lactone, lactam, hydroxyalkanoate, hydroxy ester, or other suitable compound.

In specific embodiments, the repeat units of Formula (III) are repeat units of Formula (IIIa):

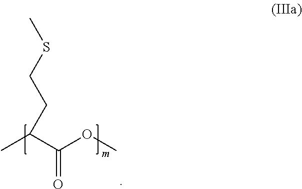

The variable m represents the number of repeat units in the polymer and is greater than 1. Those of skill in the art appreciate that polymers comprise a distribution of molecules in which m varies. The upper limit for m may be about 1000. In various embodiments, m may range up to about 10, to about 30, to about 50, to about 100, to about 200, to about 300, to about 500, or to about 800. In other embodiments, m may be greater than 2, 3, 4, 5, 6, 7, 8, 9, 10, 11, 12, 13, 14, 15, 16, 17, 18, 19, or 20. In certain embodiments, m may range from 2 to 10, from 2 to 20, from 2 to 30, from 2 to 40, or from 2 to 50.

The average molecular weight of the polymer can and will vary in different embodiments depending on the variable m and the molecular weight of the repeat unit. In various embodiments, the average molecular weight of the polymer may be at least 500 Da, at least 1000 Da, at least 1500 Da, at least 2000 Da, at least 3000 Da, at least 5,000 Da, at least 10,000 Da, at least 20,000 Da, or at least 50,000 Da. In some embodiments, the average molecular weight of the polymer may range from about 500 Da to about 2000 Da, from about 1000 Da to about 3000 Da, from about 2000 Da to about 5000 Da, from about 5000 Da to about 20,000 Da, from about 10,000 Da to about 50,000 Da, or from about 30,000 to about 100,000 Da. The average molecular weight may be a number average or a weight average. Molecular weight averages may be determined by gel permeation chromatography or other means known in the art.

In certain embodiments, the polymer may also be characterized by a monomer percent. A monomer percent is the percent of the polymer composition that is monomeric. In some aspects of the invention, the monomer percent may be less than about 10%. In other aspects, the monomer percent may be less than about 9%, less than about 8%, less than about 7%, less than about 6%, less than about 5%, less than about 4%, less than about 3%, less than about 2%, or less than about 1% of the total amount of the polymer.

The compounds of Formula (I), (la), (II), (IIa), and the repeat units of Formula (III) and (IIIa) have chiral centers. Accordingly, each chiral center may have an R or an S configuration. In compounds having more than one chiral center, the configuration at all the chiral centers may be R, may be S, or may be a combination thereof.

In general, the composition contains the adjuvant in an amount of less than 5% by weight of the composition. In some embodiments, the adjuvant is present in the composition in an amount of less than 4%, less than 3.5%, less than 3%, less than 2.5%, less than 2%, less than 1%, less than 0.5%, less than 0.25%, or less than 0.1% by weight of the composition. In one embodiment, the amount of the adjuvant in the composition is less than about 2.5% by weight of the composition. In another embodiment, the amount of the adjuvant in the composition is less than about 1.5% by weight of the composition.

(b) Fungicide

The composition also comprises at least one fungicide. The fungicide may be, by way of non-limiting example, acibenzolar; acypetacs; aldimorph; aliphatic nitrogen fungicides; amide fungicides; ampropylfos; anilazine; aureofungin; azaconazole; azithiram; azoxystrobin; β-nitrostyrene; barium polysulfide; basic copper chloride; basic copper sulfate; benalaxyl; benalaxyl-M; benodanil; benomyl; benquinox; bentaluron; benthiavalicarb; benzalkonium chloride; benzamacril; benzamide fungicides; benzamorf; benzanilide fungicides; benzimidazole fungicides; benzimidazole precursor fungicides; benzimidazolylcarbamate fungicides; benzohydroxamic acid; benzothiazole fungicides; bethoxazin; binapacryl; biphenyl; bis(dimethyldithiocarbamoyl)disulfide; bis(dimethyldithiocarbamoyl)ethylenediamine; bitertanol; bithionol; bixafen; blasticidin; bridged diphenyl fungicides; bromuconazole; bupirimate; buthiobate; calcium polysulfide; captafol; captan; carbamate fungicides; carbamorph; carbanilate fungicides; carbendazim; carboxin; carpropamid; carvone; chinomethionat; chitosan; chlobenthiazone; chloraniformethan; chloranil; chlorfenazole; chlorodinitronaphthalene; chloroneb; chloropicrin; chlorothalonil; chlorquinox; chlozolinate; ciclopirox; climbazole; clotrimazole; conazole fungicides; conazole fungicides (imidazoles); conazole fungicides (triazoles); copper 8-quinolinate; copper fungicides; copper hydroxide; copper naphthenate; copper oleate; copper oxychloride; copper sulfate, basic; copper zinc chromate; copper(II) acetate; copper(II) carbonate, basic; copper(II) sulfate; coumoxystrobin; cresol; cufraneb; cuprobam; cuprous oxide; cyazofamid; cyclafuramid; cyclic dithiocarbamate fungicides; cycloheximide; cyflufenamid; cymoxanil; cypendazole; cyproconazole; cyprodinil; dazomet; debacarb; decafentin; dehydroacetic acid; dicarboximide fungicides; dichlofluanid; dichlone; dichlorophen; dichlorophenyl; dichlozoline; diclobutrazol; diclocymet; diclomezine; dicloran; diethofencarb; diethyl pyrocarbonate; difenoconazole; diflumetorim; diisopropyl-1,3-dithiolane-2-iridene malonate; dimethirimol; dimethomorph; dimoxystrobin; diniconazole; diniconazole-M; dinitrophenol fungicides; dinobuton; dinocap; dinocap-4; dinocap-6; dinocton; dinopenton; dinosulfon; dinoterbon; diphenylamine; dipyrithione; disulfiram; ditalimfos; dithianon; dithiocarbamate fungicides; di-zinc bis(dimethyldithiocarbamate) ethylenebis (dithiocarbamate); dodemorph; dodicin; dodine; Drazoxolon; edifenphos; enoxastrobin; epoxiconazole; etaconazole; etem; ethaboxam; ethirimol; ethoxyquin; ethylene oxide; ethylmercury 2,3-dihydroxypropyl mercaptide; ethylmercury acetate; ethylmercury bromide; ethylmercury chloride; ethylmercury phosphate; ethyl-N-(3-dimethylaminopropyl)thiocarbamate hydrochloride; etridiazole; famoxadone; fenamidone; fenaminosulf; fenaminstrobin; fenapanil; fenarimol; fenbuconazole; fenfuram; fenhexamid; fenitropan; fenoxanil; fenpiclonil; fenpropidin; fenpropimorph; fentin; ferbam; ferimzone; fluazinam; fluconazole; fludioxonil; flufenoxystrobin; flumetover; flumorph; fluopicolide; fluoroimide; fluotrimazole; fluoxastrobin; fluquinconazole; flusilazole; flusulfamide; flutolanil; flutriafol; fluxapyroxad; folpet; formaldehyde; fosetyl; fuberidazole; furalaxyl; furametpyr; furamide fungicides; furanilide fungicides; furcarbanil; furconazole; furconazole-cis; furfural; furmecyclox; furophanate; glyodin; griseofulvin; guazatine; halacrinate; hexachlorobenzene; hexachlorobutadiene; hexachlorophene; hexaconazole; hexylthiofos; hydrargaphen; hymexazol; imazalil; imibenconazole; imidazole fungicides; iminoctadine; inorganic mercury fungicides; iodomethane; ipconazole; iprobenfos; iprodione; iprovalicarb; iron methanearsonate; isopropyl alcohol; isoprothiolane; isovaledione; kasugamycin; kresoxim-methyl; mancozeb; mandestrobin; maneb; mebenil; mecarbinzid; mefenoxam; mepanipyrim; mepronil; mercuric chloride; mercuric oxide; mercurous chloride; mercury fungicides; metalaxyl; metalaxyl-M (mefenoxam); metam; metazoxolon; metconazole; methasulfocarb; methfuroxam; methyl 1-(butylcarbamoyl)-2-benzimidazolecarbamate; methyl isothiocyanate; methyl-D,L-N-(2,6-dimethylphenyl)-N-(2′-methoxyacetyl)alaninate; methylmercury benzoate; methylmercury dicyandiamide; methylmercury pentachlorophenoxide; metiram; metominostrobin; metominstrobin; metrafenone; metsulfovax; milneb; morpholine fungicides; myclobutanil; myclozolin; N-(2,6-diethylphenyl)-4-methylphthalimide; N-(2,6-diethylphenyl)phthalimide; N-(3,5-dichlorophenyl)-1,2-dimethylcyclopropane-1,2-dicarboxyimide; N-(3,5-dichlorophenyl)succinimide; tetrachloroisophthalonitrile; N-(ethylmercury)-p-toluenesulfonanilide; N-2,3-dichlorophenyltetrachlorophthalamic acid; nabam; natamycin; N′-dichlorofluoromethylthio-N,N-dimethyl-N-phenylsulfamide; nickel dimethyldithiocarbamate; nitrothal-isopropyl; N-propyl-N-[2-(2,4,6-trichlorophenoxy)ethyl]imidazol-1-carboxamide; N-tetrachloroethylthio-4-cyclohexene-1,2-dicarboxyimide; N-trichloromethylthio-4-cyclohexene-1,2-dicarboxyimide; nuarimol; nystatin; O,O-diisopropyl S-benzylphosphorothioate; OCH; octhilinone; O-ethyl S,S-diphenyldithiophosphate; ofurace; oprodione; organomercury fungicides; organophosphorus fungicides; organotin fungicides; orthophenyl phenol; orysastrobin; oxadixyl; oxathiin fungicides; oxazole fungicides; oxine copper; oxpoconazole; oxycarboxin; pefurazoate; penconazole; pencycuron; pentachloronitrobenzene; pentachlorophenol; penthiopyrad; 8-phenylmercurioxyquinoline, phenylmercuriurea; phenylmercury acetate; phenylmercury chloride; phenylmercury derivative of pyrocatechol; phenylmercury nitrate; phenylmercury salicylate; 2-phenylphenol; phenylsulfamide fungicides; phosdiphen; phthalide; phthalimide fungicides; picoxystrobin; piomycin; piperalin; polycarbamate; polymeric dithiocarbamate fungicides; polyoxine; polyoxins; polyoxorim; polysulfide fungicides; potassium azide; potassium N-hydroxymethyl-N-methyldithiocarbamate; potassium polysulfide; potassium thiocyanate; probenazole; prochloraz; procymidone; propamocarb; propiconazole; propineb; proquinazid; prothiocarb; prothioconazole; pryaoxystrobin; pyracarbolid; pyraclostrobin; pyrametostrobin; pyrazole fungicides; pyrazophos; pyridine fungicides; pyridinitril; pyrifenox; pyrimethanil; pyrimidine fungicides; pyriminostrobin; pyroquilon; pyroxychlor; pyroxyfur; pyrrole fungicides; quinacetol; quinazamid; quinconazole; quinoline fungicides; quinomethionate; quinone fungicides; quinoxaline fungicides; quinoxyfen; quintozene; rabenzazole; S,S-6-methylquinoxaline-2,3-diyldithiocarbonate; salicylanilide; sec-butylamine; silthiofam; silver; simeconazole; S-n-butyl-5′-para-t-butylbenzyl-N-3-pyridyldithiocarbonylimidate; sodium azide; sodium orthophenylphenoxide; sodium pentachlorophenoxide; sodium polysulfide; spiroxamine; streptomycin; strobilurin fungicides; sulfonanilide fungicides; sulfur; sulfuryl fluoride; sultropen; tebuconazol; tebuconazole; tecloftalam; tecnazene; tecoram; tetraconazole; thiabendazole; thiadifluor; thiazole fungicides; thicyofen; thifluzamide; thiocarbamate fungicides; thiochlorfenphim; thiomersal; thiophanate; thiophanate-methyl; thiophene fungicides; thioquinox; thiram; thymol; tiadinil; tioxymid; tivedo; tolclofos-methyl; tolnaftate; tolylfluanid; tolylmercury acetate; triadimefon; triadimenol; triamiphos; triarimol; triazbutil; triazine fungicides; triazole fungicides; triazoxide; tributyltin oxide; trichlamide; tricyclazole; tridemorph; trifloxystrobin; triflumizole; triforine; triticonazole; undecylenic acid; uniconazole; uniconazole-P; urea fungicides; validamycin; valinamide fungicides; vinclozolin; voriconazole; zarilamid; zinc bis(1-hydroxy-2(1H)pyridinethionate); zinc naphthenate; zinc or manganese ethylenebis(dithiocarbamate); zinc propylenebis(dithiocarbamate); zineb; ziram; or zoxamide.

In specific embodiments, the fungicide may be a strobin fungicide. Such fungicides include, but are not limited to, azoxystrobin, coumoxystrobin, dimoxystrobin, enoxastrobin, fenaminstrobin, flufenoxystrobin, fluoxastrobin, mandestrobin, metominstrobin, orysastrobin, picoxystrobin, pyraclostrobin, pyrametostrobin, pryaoxystrobin, pyriminostrobin, and trifloxystrobin.

In other embodiments, the fungicide may be captan, metconazole, myclobutanil, and mefenoxam.

In another specific embodiment, the fungicide may be a chitosan. Chitin is a constituent of the cell walls of certain fungi, yeasts, algae, insects, and crustaceans. Chitosan is produced by deacetylation of chitin and consists of 2-acetamido-2-deoxy-β-D-glucose and 2-amino-2-deoxy-β-D-glucose as repeating units respectively. Thus, chitosan is a collective name for a group of partially and fully deacetylated chitins. The chitosan may be a commercially available chitosan with a molecular weight ranging from 3000 Da to about 400,000 Da. In one embodiment, the chitosan may have an average molecular weight of 16,000 Da or less.

The amount of the fungicide in the composition can and will vary depending on the characteristics of the fungicide and its intended use. Generally, the fungicide is present in the composition in an amount less than about 5%. More preferably, the fungicide is present in the composition in an amount less than about 1% by weight, less than about 0.9% by weight, less than about 0.8% by weight, less than about 0.7% by weight, less than about 0.6% by weight, less than about 0.5% by weight, less than about 0.4% by weight, less than about 0.3% by weight, less than about 0.2% by weight, less than about 0.1% by weight, less than about 0.05% by weight, less than about 0.01% by weight, and less than about 0.001% by weight of the composition comprising the fungicide and the adjuvant.

(c) Formulations

In come embodiments, the composition may be formulated as a liquid. As such, the amount of adjuvant present in said liquid composition is less than about 5% (w/v) of the composition. Liquid formulations are generally prepared by mixing the fungicide and the adjuvant in a liquid until dissolution of both of the compounds is achieved in the weight percentages described above. The liquid may be an aqueous, an ionic, or an organic liquid. Suitable liquids include, for example, water, alcohols (e.g., methanol and ethanol), ketones (e.g., acetone, methyl ethyl ketone and cyclohexanone), aromatic hydrocarbons (e.g., benzene, toluene, xylene, ethylbenzene and methylnaphthalene), aliphatic hydrocarbons (e.g., hexane and kerosene), esters (e.g., ethyl acetate and butyl acetate), nitriles (e.g., acetonitrile and isobutyronitrile), ethers (e.g., dioxane and diisopropyl ether), acid amides (e.g., dimethylformamide and dimethylacetamide), and halogenated hydrocarbons (e.g., dichloroethane, trichloroethylene and carbon tetrachloride).

In specific embodiments, the formulation may be an aqueous formulation. In one embodiment, an aqueous formulation contains only water, the adjuvant, and the fungicide. In other embodiments, additional compounds, solvents, or excipients may be included in the aqueous formulation. For example, the aqueous formulation may further comprise at least one pH adjusting agent or buffer agent, at least surface active agent or wetting agent, such as an alcohol alkyosylate, alkylaryl ethoxylated, or fatty amine ethoxylated, at least one oil, such as, e.g., a vegetable oil, an esterified vegetable oil, or petroleum spray oil.

In other embodiments, the composition may be formulated as a powder or a dust. In such instances, the amount of adjuvant present in said dry composition is less than about 5% (w/w) of the composition. The powder or dust may be granulated to be suitable for applying the powder or dust directly to a crop (i.e., by dusting the crop), or it may be granulated for eventual dissolution in a solvent such as water. In one embodiment, the composition is a lyophilisate. Typically, both the fungicide and the adjuvant may be lyophilized together. Alternatively, the adjuvant and the fungicide may be lyophilized separately. In other embodiments, the composition may be mixed with solid carriers such as fine powders or granules of clays (e.g. kaolin clay, diatomaceous earth, synthetic hydrated silicon dioxide, attapulgite clay, bentonite and acid clay), talcs, bulking agents, inorganic minerals (e.g., sericite, powdered quartz, powdered sulfur, activated carbon, calcium carbonate and hydrated silica), and salts for chemical fertilizers (e.g., ammonium sulfate, ammonium phosphate, ammonium nitrate, urea and ammonium chloride).

In further embodiments, the composition may be formulated as a spray in the form of an aerosol. When formulated as an aerosol spray, the formulation is generally charged in a container under pressure together with a propellant. Examples of suitable propellants include fluorotrichloromethane or dichlorodifluoromethane.

### (II) Seed Comprising a Fungicidal Composition

In another embodiment, the disclosure provides a seed comprising a fungicidal composition. The fungicidal composition is detailed above in section (I).

In the context of this disclosure a “seed” is an embryonic plant enclosed in an outer coating (i.e., a seed coat). The seed may be any seed known in the art. Seeds may be associated with the plants listed below in Section (III).

In some embodiments, the fungicidal composition may be present inside the seed coat, or internal to the seed. In other embodiments, the fungicidal composition may be outside of the seed coat, or external to the seed coat. For example, the fungicidal composition may be layered over the seed, wherein the layer covers the surface of the seed either fully or partially. The coating layer may comprise additional components, such as, e.g., natural or synthetic polymers. Examples of suitable polymers include cellulose derived polymers such as methyl cellulose, ethyl cellulose, hydroxypropylmethyl cellulose, hydroxypropyl cellulose, or hydroxypropylethyl cellulose, polyvinyl alcohol, polyacrylic acids, polymethacrylic acids, polyacrylates, polymethacrylates, polyvinyls, polyvinyl acetates, polyethylene oxides, polypropylene oxides, combinations thereof, or co-polymers of any of the foregoing. Methods for coating a seed are known in the art, e.g., see those described below in section (IV). Alternatively, the seed may be dusted with the composition, and/or mixed with the composition.

### (III) Plant Comprising a Fungicidal Composition

In another embodiment, the disclosure provides a plant comprising a fungicidal composition as described above in section (I).

The term “plant,” as used herein, includes whole plants and parts thereof, including, but not limited to, shoot vegetative organs/structures (e.g., leaves, stems and tubers), roots, flowers and floral organs/structures (e.g., bracts, sepals, petals, stamens, carpels, anthers and ovules), seed (including embryo, endosperm, and seed coat) and fruit (the mature ovary), plant tissue (e.g., vascular tissue or ground tissue) and cells (e.g., guard cells or egg cells), and progeny of the plant or any of the aforementioned parts of the plant.

The class of plants envisioned includes the class of higher and lower plants, including angiosperms (i.e., monocotyledonous and dicotyledonous plants), gymnosperms, ferns, psilophytes, lycophytes, bryophytes, and multicellular algae. In a typical embodiment, the plant may be any vascular plant, for example monocotyledons or dicotyledons or gymnosperms, including, but not limited to alfalfa, apple, arabidopsis, banana, barley, canola, castor bean, chrysanthemum, clover, cocoa, coffee, cotton, cottonseed, corn, crambe, cranberry, cucumber (curcurbit), dendrobium, dioscorea, eucalyptus, fescue, flax, gladiolus, liliacea, linseed, millet, muskmelon, mustard, oat, oil palm, oilseed rape, papaya, peanut, pepper, pineapple, ornamental plants, Phaseolus, potato, rapeseed, rice, rye, ryegrass, safflower, sesame, sorghum, soybean, sugarbeet, sugarcane, sunflower, strawberry, tobacco, tomato, turfgrass, wheat and vegetable crops such as lettuce, celery, broccoli, cauliflower, cucurbits; fruit and nut trees, such as apple, pear, peach, orange, grapefruit, lemon, lime, almond, pecan, walnut, hazel; vines, such as grapes, kiwi, hops; fruit shrubs and brambles, such as raspberry, blackberry, gooseberry; forest trees, such as ash, pine, fir, maple, oak, chestnut, popular; or an agriculturally important plant such as alfalfa, canola, corn, cotton, crambe, flax, linseed, mustard, oil palm, oilseed rape, peanut, potato, rice, safflower, sesame, soybean, sugarbeet, sunflower, tobacco, tomato, and wheat.

The fungicidal composition may be present inside the plant. For example, the composition may be absorbed by the plant (e.g., leaves, roots, etc.) distributed through the plant vascular system. Alternatively, the fungicidal composition may remain on an external surface of the plant (i.e., the composition is not absorbed). For example, the fungicidal composition may form a coating, a film, or a layer on the exterior of the plant or plant part, thereby preventing entry of the fungus into the plant. Suitable plant parts include leaf, vascular tissue, flower, root, stem, tuber, seed, fruit, or combinations thereof. Means for applying fungicidal compositions to plants are known in the art and are detailed below in section (IV).

### (IV) Methods for Treating or Preventing Fungal Infections

The disclosure further provides methods for treating or preventing fungal infections in plants by applying an effective amount of any of the fungicidal compositions detailed above in section (I).

(a) Fungal infection

The fungal infection that may be treated or prevented is not limited. In this regard, the fungal infection may be chosen from fungi such as of the genera Aspergillus, Venturia, Podosphaera, Erysiphe, Monolinia, Mycosphaerella, Penicillium, and Uncinula; Basidiomycete fungi such as from the genera Hemileia, Rhizoctonia, and Puccinia; Fungi imperfecti such as the genera Botrytis, Helminthosporium, Rhynchosporium, Fusarium, Septoria, Cercospora, Alternaria, Pyricularia, and Pseudocercosporella; Oomycete fungi such as from the genera Phytophthora, Peronospora, Bremia, Pythium, and Plasmopara; as well as other fungi such as Phakopsora Pachyrhizi, P. meibomiae, Scleropthora macrospora, Sclerophthora rayissiae, Sclerospora graminicola, Peronosclerospora sorghi, Peronosclerospora philippinensis, Peronosclerospora sacchari and Peronosclerospora maydis, Physopella zeae, Cercospora zeae-maydis, Colletotrichum graminicola, Gibberella zeae, Exserohilum turcicum, Kabatiellu zeae, and Bipolaris maydis.

In specific embodiments, the fungal infection may be caused by Botrytis cinera, Fusarium graminearum, Fusarium oxysporum, Podosphaera xanthii, Rhizoctonia solani, Verticillium dahlia, and combinations thereof. In other embodiments, the fungal infection may be due to Puccini spp., Tilletia spp., Ustilago tritici, Urocystis agropyri, Erysiphe graminis f. sp. tritici, Septoria spp., Cochliobolus sativus, Pyrenophora trichostoma, Alternaria triticina, Fusarium spp., and other fungi that infect wheat. In further embodiments, the fungal infection may be Puccinia sorghi, Exserohilum turcicum, Kabatiella zeae, Cercospora zeae-maydis, Fusarium spp., and other fungi that infect corn (maize). In still other embodiments, the fungal infection may be Fusarium spp., Rhizoctonia solani, Phytophthora sojae, Pythium spp., and other species that infect soybeans. In certain embodiments, fungal infection is Fusarium, Phytophthora, Monilinia, Botrytis, Podosphaera, Rhizoctonia, Verticillium, or combinations thereof.

(b) Applications

The fungicidal composition may be applied to a plant prior to infection to prevent a fungal infection. The fungicidal composition may also be applied after the appearance of signs of infection to treat a fungal infection. The composition may be applied by a variety of methods depending on the plant part to be treated. By way of example, the composition may be applied to a plant seed prior to planting to prevent fungal infection of the seed. The composition may be applied to the soil at the time of planting or just before planting to prevent microbial infestation of the newly planted seed (i.e., preemergent). Alternatively, the composition may be applied to a plant after its germination or to the foliage of the plant after emergence to either treat or prevent microbial infestation (i.e., postemergent). In specific embodiments, applications occur during the stages of germination, seedling growth, vegetative growth, and reproductive growth. More typically, applications occur during vegetative and reproductive growth stages.

The term composition does not mean that the two components must be applied at the same time or as a part of the same application. It is contemplated, for example, that the fungicide and the adjuvant may be applied as part of the same mixture or in sequence.

Applying the composition to a preemergent seed may involve various seed coating techniques such as film coating, pelleting, encapsulation, drum coating, and fluidized bed coating. Applying the compositions to a postemergent plant may involve spraying or crop dusting techniques.

Typically, an effective amount of the composition is applied to a plant or seed by several methods generally known in the art. As will be appreciated by a skilled artisan, the amount of composition comprising an “an effective amount” can and will vary depending upon the plant and its stage of production, the fungal target, and environmental conditions. Generally speaking, for a typical application, the plant or its progeny is treated with an amount of the composition sufficient to provide a concentration of active ingredients from about 0.01 mg/kg to about 10% by weight. It is envisioned that the method may involve more than one application of the composition to the plant or its progeny. For example, the number of applications may range from about 1 to about 5 or more. The applications, as detailed herein, may be made at the same or different stages of the plant's life cycle.

Without being bound to any theory, it is thought that the compositions provided herein form a film coating on the plant or seed when applied. This film coating may provide adhesion of the fungicide to the relevant plant part. The film coating may also provide a barrier that protects against spread and re-infestation of the plant. The physical properties of the film, such as its pH, may also result in certain plant parts being receptive to the fungicide.

(c) Activity

The compositions and methods described herein may produce antifungal activity greater than the antifungal activity of the fungicide alone.

In one embodiment, antifungal activity may be calculated by the Area Under Disease Progress Curve (AUDPC) using Abbott's formula to correct for control mortality. As measured by AUDPC, the fungicidal compositions herein result in pest control in a plant (or plant part) that may be at least 5%, at least 10%, at least 15%, at least 20%, at least 25%, at least 30%, at least 35%, or at least 40% higher than in a plant (or plant part) treated with fungicide alone.

In another embodiment, antifungal activity may be characterized by reduced pest severity (e.g., using a visual scoring system based the extent of plant damage). In such embodiments, pest severity may be reduced by at least 5, at least 10%, at least 15%, at least 20%, at least 25%, at least 30%, at least 35%, or at least 40% compared to a plant (or plant part) treated with fungicide alone.

### Definitions

When introducing elements of the embodiments described herein, the articles “a”, “an”, “the” and “said” are intended to mean that there are one or more of the elements. The terms “comprising”, “including” and “having” are intended to be inclusive and mean that there may be additional elements other than the listed elements.

The compounds described herein have asymmetric centers. Compounds of the present invention containing an asymmetrically substituted atom may be isolated in optically active or racemic form. All chiral, diastereomeric, racemic forms and all geometric isomeric forms of a structure are intended, unless the specific stereochemistry or isomeric form is specifically indicated.

As used herein, the term “about,” particularly in reference to a given quantity, is meant to encompass deviations of plus or minus five percent.

Having described the invention in detail, it will be apparent that modifications and variations are possible without departing from the scope of the invention defined in the appended claims.

### EXAMPLES

The following examples are included to demonstrate preferred embodiments of the invention. It should be appreciated by those of skill in the art that the techniques disclosed in the examples that follow represent techniques discovered by the inventors to function well in the practice of the invention. Those of skill in the art should, however, in light of the present disclosure, appreciate that changes may be made in the specific embodiments that are disclosed and still obtain a like or similar result without departing from the spirit and scope of the invention. Therefore, all matter set forth or shown in the accompanying drawings is to be interpreted as illustrative and not in a limiting sense.

### Example 1: Chitosan/HMTBA Blends

Step A: Preparation of low molecular weight (LMW) chitosan.

LMW chitosan samples were prepared by means of acid hydrolysis of chitosan. Chitosan (200 kDa) was treated with various amount of HCl and/or for varying periods of time to produce chitosan sample of different molecular weight. Characteristics of four samples, (C1-C4) are provided below in Table 1.

TABLE 1
Characteristics of chitosan hydrolysates.

| Sample No. | C1 | C2 | C3 | C4 |
|---|---|---|---|---|
| Mw | 3.12 kDa | 9.53 kDa | 15.21 kDa | 36.06 kDa |
| Mw/Mn | 1.13 | 1.86 | 2.14 | 1.99 |

Step B: Preparation of Chitosan/HMTBA Blend.

To prepare a chitosan/HMTBA blend, a chitosan sample (12 g), listed in Table 1, was dissolved in 120 mL water in the presence of 11.7 g (105 mol %) HMTBA. The resultant solution was lyophilized, and chitosan/HMTBA was collected, dried over P₂O₅ under vacuum at 20° C. and kept in a dark-glass tube.

### Example 2: Inhibition of Fungal Colony Radial Growth by Chitosan/HMTBA Blends

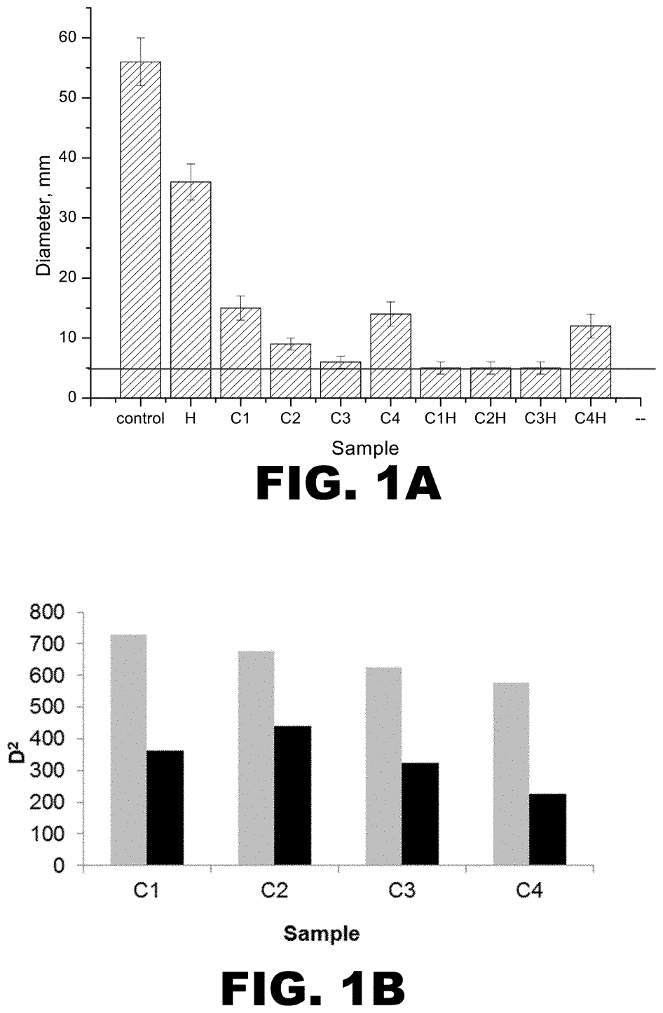

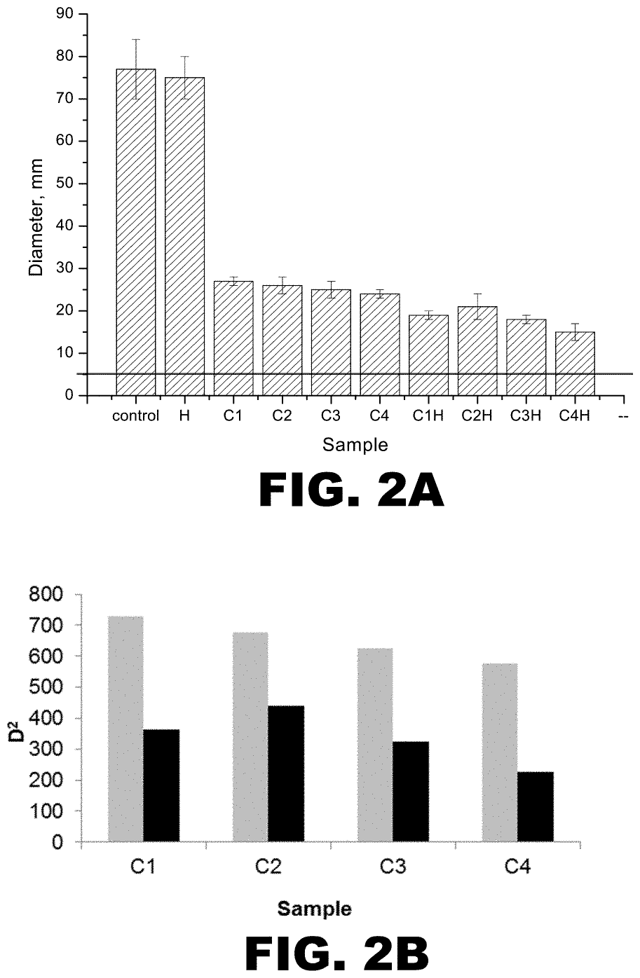

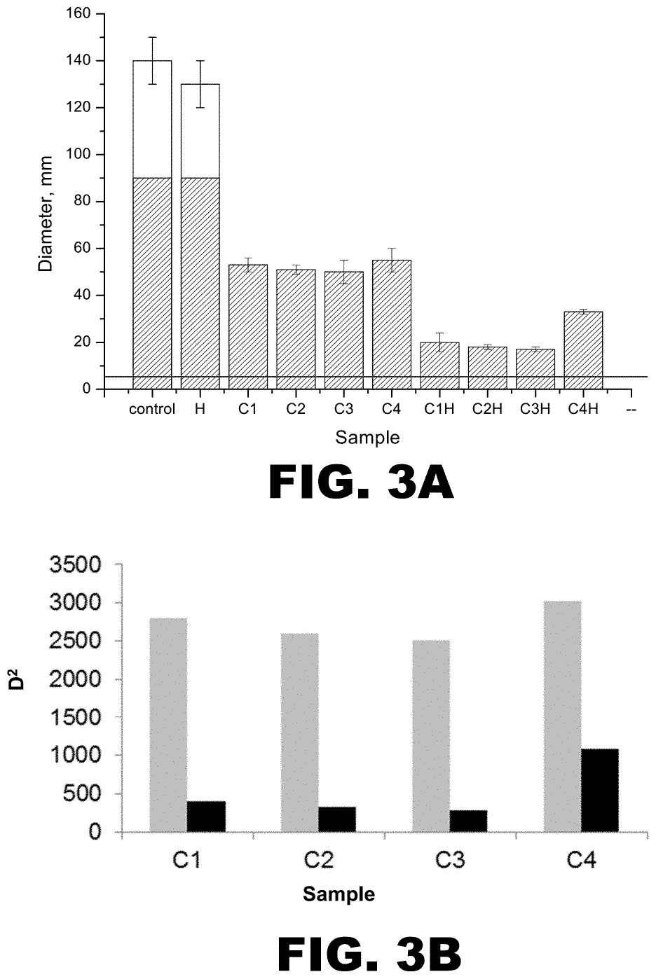

Fungistatic activities of chitosan hydrochlorides (Example 1, Step A product), chitosan/HMTBA blends (Example 1, Step B product), and HMTBA were determined by a radial hyphal growth bioassay on agar plates. To prepare the medium for the agar plates, chitosan hydrochloride (C1-C4 (Table 1), 0.5% w/v), chitosan/HMTBA blend (i.e. C1H-C4H, 1.0% w/v), or HMTBA (0.5% w/v) was dissolved in 150 mL water, and 11.5 g Antifungal Assay Agar (AAA; 76 g/L) was added. The pH of each solution was adjusted to pH 4.7. Control plates did not contain chitosan, chitosan/HMTBA, or HMTBA. The media was sterilized at 121° C. for 10 min and then poured onto sterile 90 mm diameter Petri plates (about 10 mL/plate). The plates were inoculated with 4 mm diameter plugs taken from the margins of Verticillium dahlia, Fusarium oxysporum, Rhizoctonia solani fungal colonies, and incubated at 21° C. in the dark. Radial colony growth was measured at day 20, day 15 and day 23 for V. dahlia, F. oxysporum, and R. solani, respectively (FIGS. 1A, 1B, 2A, 2B, 3A, and 3B). The chitosan/HMTBA blends inhibited fungal growth to a greater extent than chitosan alone.

### Examples 3-5: In Vitro Methods

Experimental Unit.

In vitro testing utilized plates of selective media specific to the pest of interest, inoculated with fungicide, HMTBA, or both. Leaf disc assays were employed for testing efficacy of treatments against powdery mildew. Mycelial disc assays were performed for testing the efficacy of the treatments against mycelium and spore production of Fusarium and Botrytis. For both the leaf disc and mycelial disc assays, three discs per petri-plate (replicated six times) were evaluated for each treatment.

Application Equipment.

Fungicide and HMTBA mixed into media at 45° C. before solidification with a micropipette for Fusarium and Botrytis trials. Miniature sprayer (TeeJet TXVK-8 hollow cone spray nozzle attached to syringe) was used for spraying cucumber cotyledons for the powdery mildew trial.

Data Analysis.

All calculations for averages and percent control were carried out using ARM9 Software (Gylling Data Management). Abbot's formulation for percent control. All statistics were analyzed using ANOVA mean comparison with LSD test and α=0.05. Bartlett's test for homogeneity of variances was used to determine the need for data transformations. Letters in tables represent means separation significant and 0.05.

### Example 3: HMTBA Improves the Fungicidal Activity of Azoxystrobin In Vitro

To evaluate if the efficacy of azoxystrobin was improved by the addition of HMTBA, a leaf disc assay was employed for testing against Podosphaera xanthii (powdery mildew). The powdery mildew isolates were collected from cucumber plants grown at Florida Ag Research, Thonotosassa, Fla. Cucumber cotyledons with fresh disease infections were harvested and put in to a solution of 10 pg/ml sodium dodecyl sulfate (SDS) to wash the conidia off and the spore suspension was diluted to 30-40 spores per field of vision (10×10 times under microscope). Newly planted cucumber cotyledons were uniformly inoculated using a miniature sprayer.

Concentrations of azoxystrobin (trade name QUADRIS) at 0.0001, 0.001, 0.01, 0.1 and 1.0% active ingredient to volume (ai/v) were applied to determine the critical concentration of azoxystrobin. Leaf discs (9 mm in diameter) were removed from cotyledons with a cork borer after inoculation and application. These leaf discs were placed on a culture medium (1% agar+1% sugar+5 μg/ml benzimidazole) in petri dishes and incubated at 25° C. with a 14 hour photoperiod.

Disease severity was investigated when disease symptoms were at their peak. The disease severity rating was carried out by means of a 0 to 4 rating scale, where 0=disc center is completely green, 1=small amount of mycelia or lesion is visible with area less than 10% of entire disc, 2=lesion area equals approximately 30% of the entire disc, 3=lesion area equals approximately 60% of the entire disc, 4=lesion or spores cover the entire disc. Similar procedures followed for testing the effect of HMTBA and HMTBA in combination with azoxystrobin for control of powdery mildew.

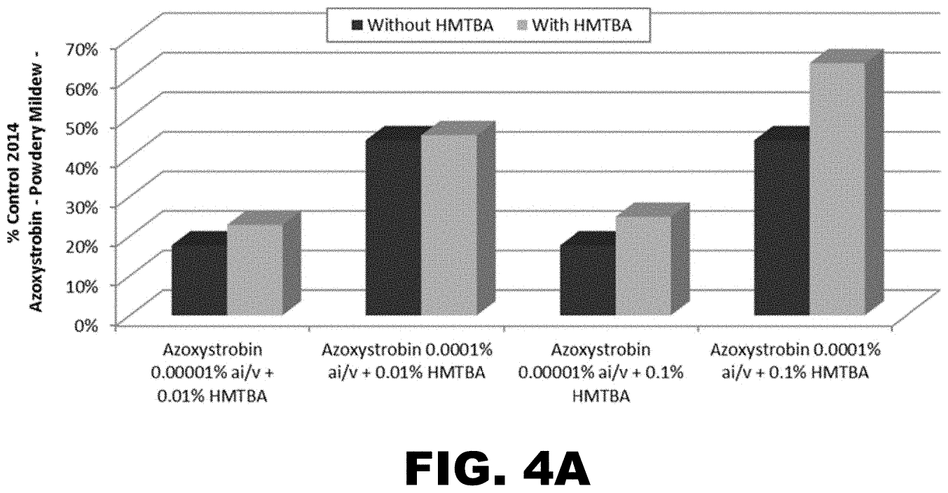

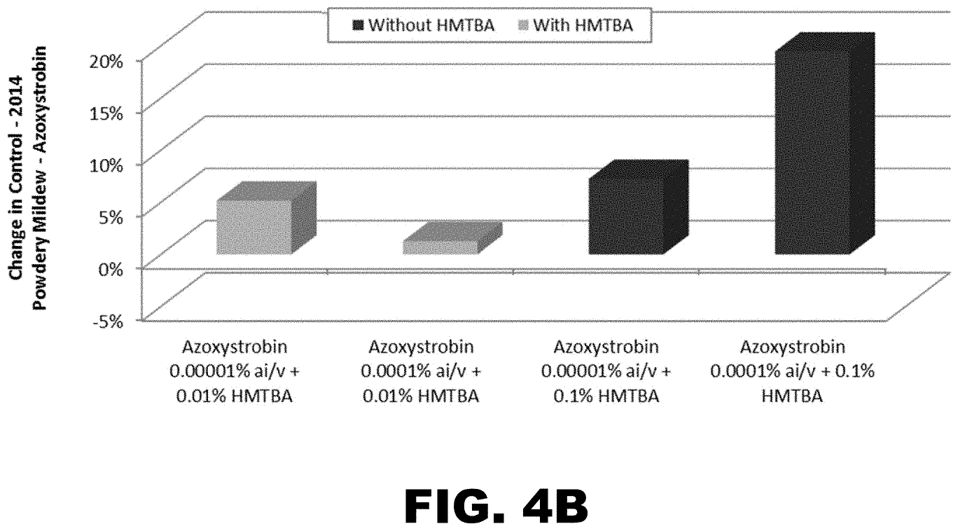

Table 2 presents the average pest severity score for each condition. The percent of disease control and the percent change in control (i.e., the difference in control provided by Azoxystrobin with and without HMTBA) are also present in Table 2 and FIGS. 4A and 4B. These data show that the combination of azoxystrobin and HMTBA improved powdery mildew control at all concentrations tested. The combination exhibited a synergistic effect, i.e., the size of the effect was greater than that predicted by adding the effect of each agent alone. For example, Trt. 2 (0.1% HMTBA)+Trt. 4 (0.0001% Azoxystrobin)<Trt. 9 (0.0001% Azoxystrobin+0.1% HMTBA).

TABLE 2
The in vitro efficacy of azoxystrobin against Podosphaera xanthii
(powdery mildew) was improved by the addition of HMTBA.

| | | Pest Severity | | |
|---|---|---|---|---|
| Trt. | | Score | P. xanthii | % Control |
| No. | Treatment Name | 0-4 | % Control | Change |
| 1 | Selective Media | 3.17 a | 0.00% f | — |
| 2 | Selective Media | 3.17 a | 4.46% ef | — |
| | 0.1% HMTBA | | | |
| 3 | Selective Media | 2.67 ab | 17.66% de | — |
| | Azoxystrobin 0.00001% ai/v | | | |
| 4 | Selective Media | 1.75 c | 44.23% c | — |
| | Azoxystrobin 0.0001% ai/v | | | |
| 5 | Selective Media | 0.08 e | 97.62% a | — |
| | Azoxystrobin 0.1% ai/v | | | |
| 6 | Selective Media | 2.5 b | 22.82% d | 5.16% |
| | Azoxystrobin 0.00001% ai/v | | | |
| | 0.01% HMTBA | | | |
| 7 | Selective Media | 1.67 cd | 45.50% c | 1.27% |
| | Azoxystrobin 0.0001% ai/v | | | |
| | 0.01% HMTBA | | | |
| 8 | Selective Media | 2.33 b | 24.90% d | 7.24% |
| | Azoxystrobin 0.00001% ai/v | | | |
| | 0.1% HMTBA | | | |
| 9 | Selective Media | 1.17 d | 63.69% b | 19.46% |
| | Azoxystrobin 0.0001% ai/v | | | |
| | 0.1% HMTBA | | | |

### Example 4: HMTBA Improves the Fungicidal Activity of Captan In Vitro

Botrytis cinerea isolates were collected from the Florida Ag Research farm and pure cultures of Botrytis isolates were maintained on Potato Dextrose Agar (PDA) media. Captan (trade name CAPTEC) at concentrations of 0.0001%, 0.001%, 0.01%, 0.1%, and 1.0% active ingredient to volume (ai/v) were mixed in the PDA media at 45° C. before solidification to determine the critical concentration of the fungicide against Botrytis. Agar discs were cut from actively growing mycelium plugs (5 mm in diameter) from three day old cultures and placed with the surface mycelium face down on petri dishes containing different rates of the fungicide mixed with media or on petri dishes containing only media (untreated control). The colony diameters were measured after incubation for four days at 23° C. in the dark.

Mycelium disc (inside of treated or untreated petri plates) diameter was measured three to four days after incubation to determine the inhibition of mycelia growth. Three random mycelia discs were used to study the effect of spore production which was determined by using a haemocytometer after seven to eight days of incubation. Similar procedures followed for testing the effect of HMTBA and HMTBA in combination with captan for control of Botrytis.

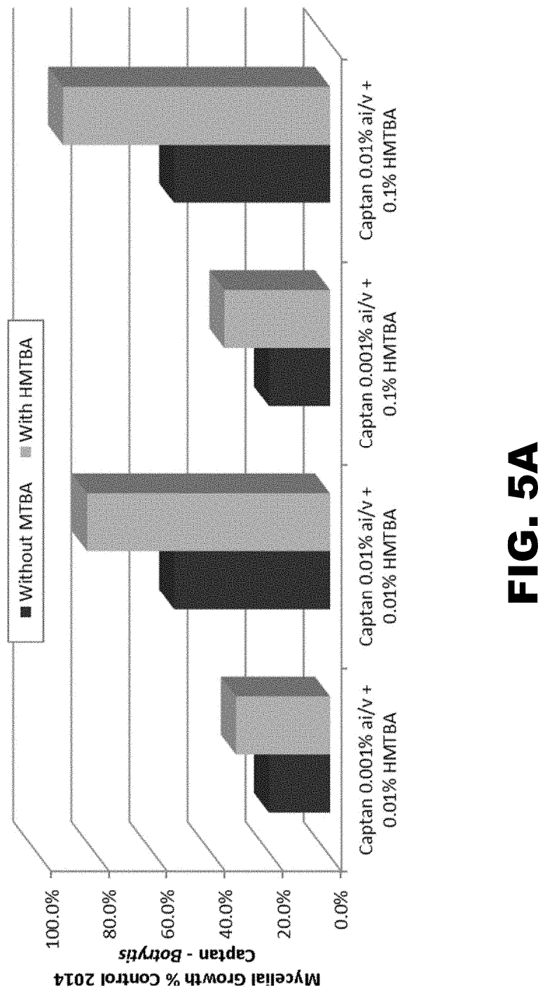

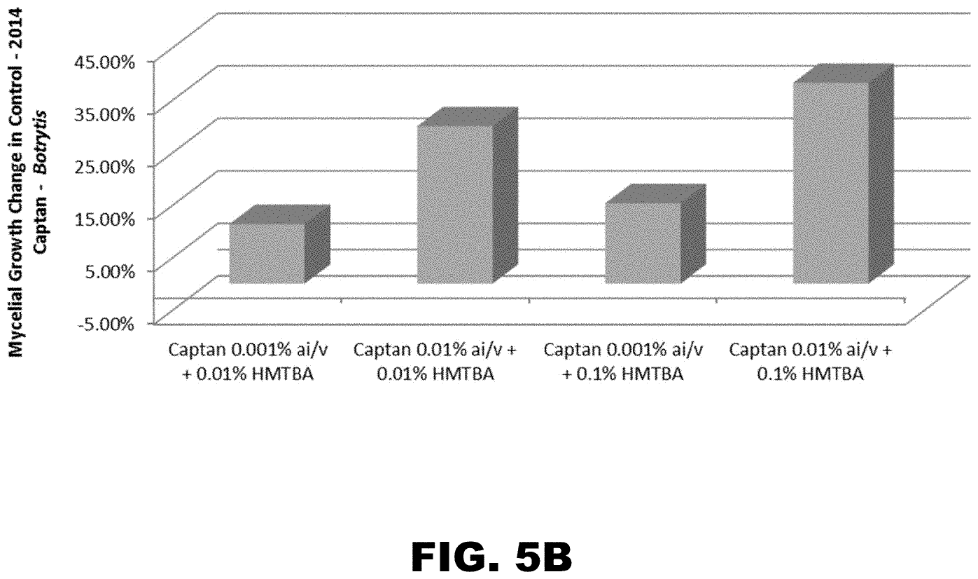

As shown in Table 3 and FIGS. 5A and 5B, the combination of captan and HMTBA improved grey mold control at all concentrations tested. Again, the combination of HMTBA with a fungicide, captan, exhibited a synergistic effect. For example, Trt. 2 (0.1% HMTBA)+Trt. 3 (0.001% captan)<Trt. 8 (0.001% captan+0.1% HMTBA) in Table 3; and Trt. 2 (0.1% HMTBA)+Trt. 4 (0.01% captan)<Trt. 9 (0.01% captan+0.1% HMTBA) in Table 3.

TABLE 3
The in vitro efficacy of captan against B. cinerea (grey mold)
mycelial growth was improved by the addition of HMTBA.

| Trt. | | B. cinerea Mycelial Growth | | % Control |
|---|---|---|---|---|
| No. | Treatment Name | Diameter (cm) | % Control | Change |
| 1 | Selective Media | 2.12 a | 0.00% e | — |
| 2 | Selective Media | 2.03 ab | 10.08% de | — |
| | 0.1% HMTBA | | | |
| 3 | Selective Media | 1.68 bc | 21.05% cd | — |
| | Captan 0.001% ai/v | | | |
| 4 | Selective Media | 0.97 d | 53.68% b | — |
| | Captan 0.01% ai/v | | | |
| 5 | Selective Media | 0.07 e | 96.81% a | — |
| | Captan 1% ai/v | | | |
| 6 | Selective Media | 1.42 c | 32.40% c | 11.35% |
| | Captan 0.001% ai/v | | | |
| | 0.01% HMTBA | | | |
| 7 | Selective Media | 0.35 e | 83.68% a | 30.00% |
| | Captan 0.01% ai/v | | | |
| | 0.01% HMTBA | | | |
| 8 | Selective Media | 1.33 cd | 36.37% c | 15.32% |
| | Captan 0.001% ai/v | | | |
| | 0.1% HMTBA | | | |
| 9 | Selective Media | 0.17 e | 91.94% a | 38.26% |
| | Captan 0.01% ai/v | | | |
| | 0.1% HMTBA | | | |

### Example 5: HMTBA Improves the Fungicidal Activity of Metconazole In Vitro

Fusarium gramenarium cultures received from USDA-ARS, Fort Pierce, Fla. were used in this study. Cultures were maintained on selective media. Different concentrations of metconzale (trade name QUASH) at 0.0001%, 0.001%, 0.01%, 0.1%, and 1.0% active ingredient to volume (ai/v) were mixed in PDA media before solidification (at 45° C.) to determine the critical concentration of the fungicide against Fusarium. Agar discs were cut from actively growing mycelium plugs (5 mm in diameter) obtained from four day old cultures and placed with the surface mycelium face down on petri dishes containing different rates of the fungicide mixed with media or on petri dishes containing only media (untreated control). The colony diameters were measured after incubation for four days at 23° C. in the dark.

To determine the effect on conidial spore production, three agar discs (1 cm in diameter) were randomly taken from each treatment after 7 days of incubation. The discs were placed in 1.5 ml of sterile distilled water. The tubes with discs were shaken for 1 min, then the suspension was filtered through a layer of muslin cloth and the sporangial concentration was determined microscopically using a haemocytometer. Similar procedures were followed for testing the effect of HMTBA and HMTBA in combination with metconazole for control of Fusarium.

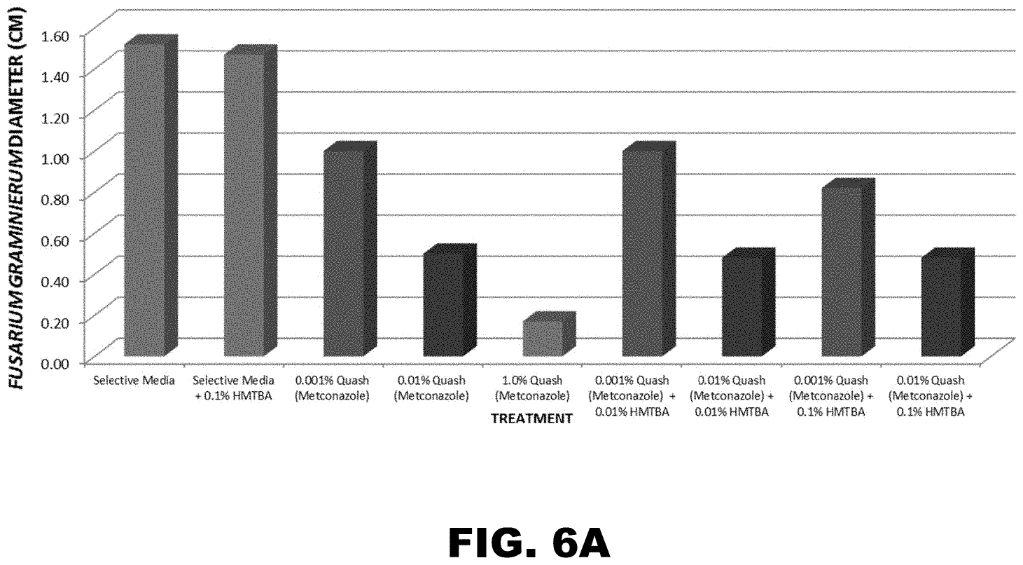

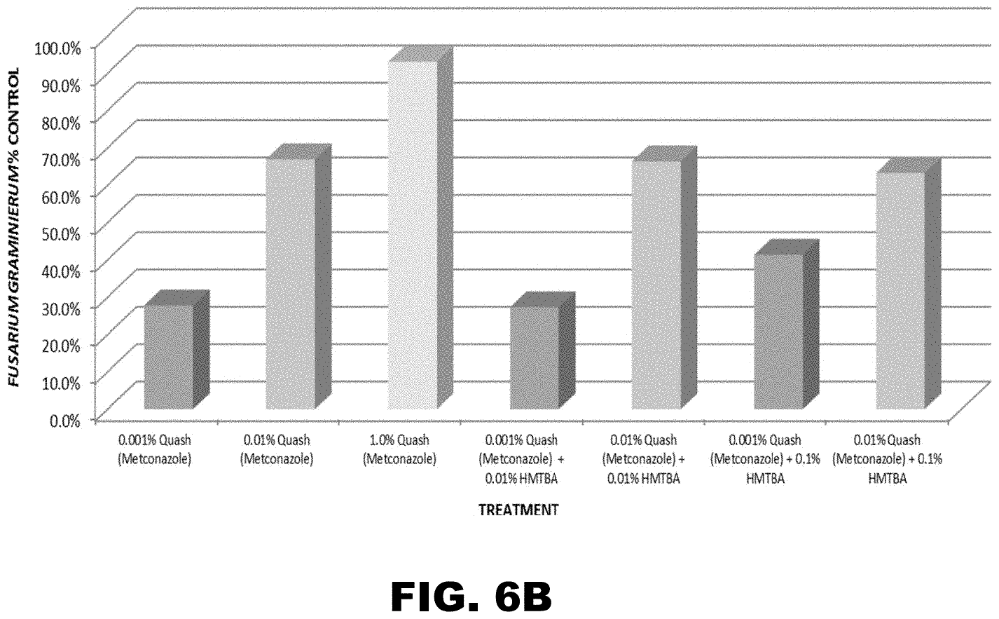

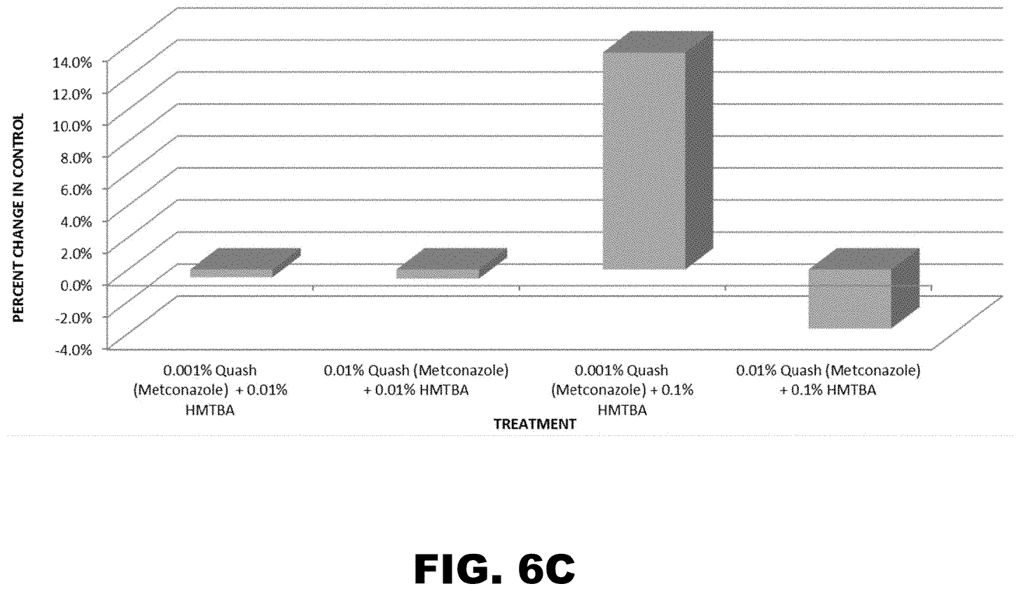

As shown in Table 4 and FIGS. 6A, 6B, and 6C, the combination of 0.001% ai/v metconazole and 0.1% HMTBA improved Fusarium wilt control, and provided a synergistic effect.

TABLE 4
The in vitro efficacy of metconazole against Fusarium graminiearum
(Fusarium wilt) was improved by the addition of HMTBA.

| Trt. | | Spore | F. | % |
|---|---|---|---|---|
| | | Diameter | graminiearum | Control |
| No. | Treatment Name | (cm) | % Control | Change |
| 1 | Selective Media | 1.52 a | 0.00% f | — |
| 2 | Selective Media | 1.47 a | 4.93% ef | — |
| | 0.1% HMTBA | | | |
| 3 | Selective Media | 1.00 b | 27.80% cde | — |
| | Metconazole 0.001% | | | |
| | ai/v | | | |
| 4 | Selective Media | 0.50 cd | 66.98% ab | — |
| | Metconazole 0.01% ai/v | | | |
| 5 | Selective Media | 0.17 d | 93.08% a | — |
| | Metconazole 1% ai/v | | | |
| 6 | Selective Media | 1.00 b | 27.32% de | −0.48% |
| | Metconazole 0.001% | | | |
| | ai/v | | | |
| | 0.01% HMTBA | | | |
| 7 | Selective Media | 0.48 cd | 66.41% ab | −0.57% |
| | Metconazole 0.01% ai/v | | | |
| | 0.01% HMTBA | | | |
| 8 | Selective Media | 0.82 bc | 41.36% bcd | 13.56% |
| | Metconazole 0.001% | | | |
| | ai/v | | | |
| | 0.1% HMTBA | | | |
| 9 | Selective Media | 0.48 cd | 63.30% bc | −3.68% |
| | Metconazole 0.01% ai/v | | | |
| | 0.1% HMTBA | | | |

### Example 6: HMTBA is not Phytotoxic to Cucurbit, Strawberry, Pepper, and Lettuce Crops

These experiments were carried out to test the phytotoxic effects of HMTBA on cucurbit (cucumber), strawberry, pepper, and lettuce target crops. Young plants of Jackson Classic variety cucumber, Tango variety head lettuce, Compadre variety bell pepper, and Festival variety strawberry were grown under standard greenhouse conditions. One week-post planting cucumber and pepper plants, three week old lettuce, and four month old strawberry plants were treated.

Foliar sprays for HMTBA dilutions at 0.01, 0.1, 0.2 and 1.0% ai/v were applied twice per week for two weeks (total of four applications).

Height and width for each plant was measured (centimeters) for indication of growth changes between treated and untreated plants. Phytotoxicity ratings were taken weekly on a 0-10 scale, where 0 indicates no crop injury and 10 is damage (yellowing, scarring, wilting, necrosis, death) to the total plant from the treatment.

All calculations were carried out using ARM9 Software (Gylling Data Management). Area Under Disease Progress Curve (AUDPC), Abbot's formulation for percent control and all statistics were analyzed using ANOVA mean comparison with LSD test and a=0.05. Bartlett's test for homogeneity of variances was used to determine the need for data transformations. Letters in tables represent means separation significant and 0.05.

For each crop, plant growth was unchanged from the untreated check and no phytotoxic effects were recorded. Tables 5-8 below show the phototoxicity ratings for each experiment, as assessed 2 or 3 days after Application A (2 DA-A or 3 DA-A) and 3 days after Application C (3 DA-C). Data points are the average of five plants. These experiments demonstrate that HMTBA at a rate of up to and including 1% does not cause crop injury.

TABLE 5
Cucumber Phytotoxicity.

| Trt. | | Rating (0-10) | |
|---|---|---|---|
| No. | Treatment Name | 3 DA-A | 3 DA-C |
| 1 | Untreated Check | 0.0 a | 0.0 a |
| 2 | HMTBA 0.01% ai/v | 0.0 a | 0.0 a |
| 3 | HMTBA 0.1% ai/v | 0.0 a | 0.0 a |
| 4 | HMTBA 0.2% ai/v | 0.0 a | 0.0 a |
| 5 | HMTBA 1.0% ai/v | 0.0 a | 0.3 a |

TABLE 6
Lettuce Phytotoxicity.

| Trt. | | Rating (0-10) | |
|---|---|---|---|
| No. | Treatment Name | 2 DA-A | 3 DA-C |
| 1 | Untreated Check | 0.0 a | 0.0 b |
| 2 | HMTBA 0.01% ai/v | 0.0 a | 0.0 b |
| 3 | HMTBA 0.1% ai/v | 0.0 a | 0.0 b |
| 4 | HMTBA 0.2% ai/v | 0.0 a | 0.0 b |
| 5 | HMTBA 1.0% ai/v | 0.0 a | 1.0 a |

TABLE 7
Pepper Phytotoxicity.

| Trt. | | Rating (0-10) | |
|---|---|---|---|
| No. | Treatment Name | 3 DA-A | 3 DA-C |
| 1 | Untreated Check | 0.0 a | 0.0 a |
| 2 | HMTBA 0.01% ai/v | 0.0 a | 0.0 a |
| 3 | HMTBA 0.1% ai/v | 0.0 a | 0.0 a |
| 4 | HMTBA 0.2% ai/v | 0.0 a | 0.0 a |
| 5 | HMTBA 1.0% ai/v | 0.0 a | 0.0 a |

TABLE 8
Strawberry Phytotoxicity.

| Trt. | | Rating (0-10) | |
|---|---|---|---|
| No. | Treatment Name | 2 DA-A | 3 DA-C |
| 1 | Untreated Check | 0.0 a | 0.0 a |
| 2 | HMTBA 0.01% ai/v | 0.0 a | 0.0 a |
| 3 | HMTBA 0.1% ai/v | 0.0 a | 0.0 a |
| 4 | HMTBA 0.2% ai/v | 0.0 a | 0.0 a |
| 5 | HMTBA 1.0% ai/v | 0.0 a | 0.0 a |

### Example 7: Greenhouse Powdery Mildew on Cucurbit Assay

To further demonstrate that the efficacy of azoxystrobin was improved by the addition of HMTBA salt, powdery mildew severity on greenhouse grown Gentry variety summer squash plants was assessed following azoxystrobin treatment with and without HMTBA. Gentry variety summer squash plants in 1 gallon pots were placed 12 inches apart and inoculated with powdery mildew of cucurbits (Podosphaera xanthii).

The plants were sprayed to run-off with the solution of the appropriate concentration. The fungicide concentration of the mix was the same as a field rate in which 15,000 plants per acre were grown. One-hundred gallons per acre of treatment applications were sprayed using a Flo-Master compressed CO₂ sprayer with boom incorporating a single nozzle. Treatments included azoxystrobin at 0.18 lb ai/a (0.021% v/v) with and without HMTBA (three rates: 0.107, 0.536 and 1.073% v/v). An untreated check was included for reference. Each treatment arm received five applications (A, B, C, D, E), with approximately one week between each application. Table 9 summarizes the treatments.

TABLE 9
Treatment List.

| Trt | Treatment | | Rate | Appl |
|---|---|---|---|---|
| No. | Name | Rate | Unit | Code |
| 1 | Azoxystrobin | 0.18 | lb ai/a | A-E |
| | 0.021% v/v | | | |
| 2 | Azoxystrobin | 0.18 | lb ai/a | A-E |
| | 0.021% v/v | 0.1073 | % v/v | A-E |
| | HMTBA | | | |
| 3 | Azoxystrobin | 0.18 | lb ai/a | A-E |
| | 0.021% v/v | 0.536 | % v/v | A-E |
| | HMTBA | | | |
| 4 | Azoxystrobin | 0.18 | lb ai/a | A-E |
| | 0.021% v/v | 1.073 | % v/v | A-E |
| | HMTBA | | | |
| 5 | Untreated Check | | | |

Each application, i.e. A-E, occurred approximately one week apart.

Powdery mildew severity was rated on 5 plants per plot on a 0-10 scale (0 is no pest damage and 10 is a severe infestation) for the whole plant for each assessments. Pest incidence (percent of plants with signs of disease), the area under the disease progress curve (AUDPC) and percent disease control (Abbott's formula) calculations were performed in ARM9 software (Gylling Data Management). Bartlett's test for homogeneity of variances was used to determine the need for data transformations. Letters in tables represent means separation significant and 0.05.

AUDPC calculates the average disease intensity between each pair of adjacent time points. It is calculated by determining the average distance in rise of disease intensity for each evaluation date and adding them together by treatment. The equation for calculation is as follows:

$${\sum }_{t = 1}^{N i - 1} \frac{{y}_{i} - {y}_{i - 1}}{2} ( {t}_{i} - {t}_{1 - 1} )$$

where y=severity, t=time, N=average disease intensity between two adjacent time points. Percent disease control expresses the severity of fungal disease infection in treated plots, compared to plants in the untreated check. It was calculated using the Abbott formula. The equation for calculation is as follows:

$$Corrected \% = ( 1 - \frac{n in T after treatment}{n in Co after treatment )} * 100 )$$

where: n=disease pressure, T=treated, Co=control.

Powdery mildew severity was rated on five plants/plot on 3 days after Application A (3DA-A), 1 day after Application B (1 DA-B), 6 days after Application B (6 DA-B), 5 days after Application C (5 DA-C), and 1 day after Application E (1 DA-E).

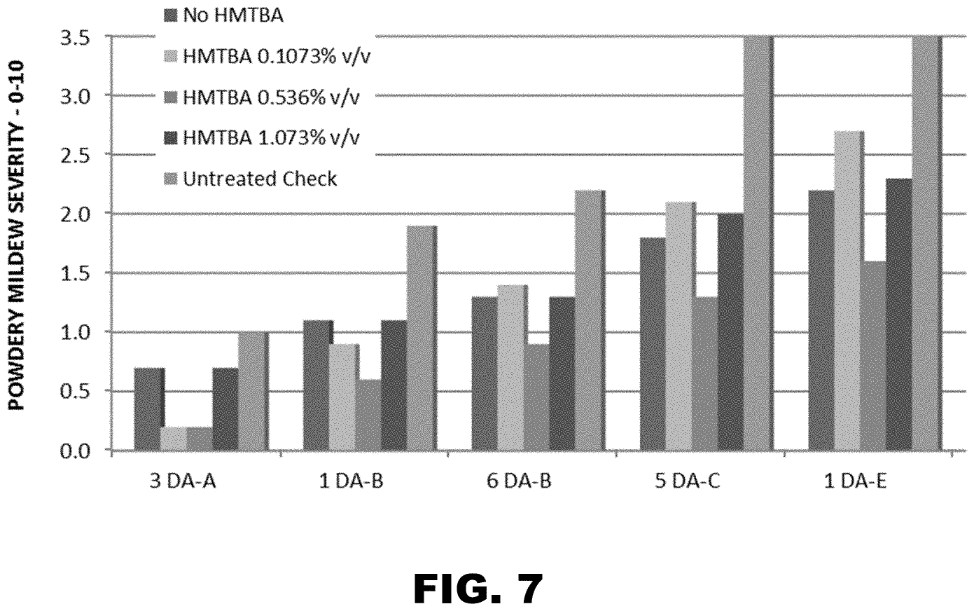

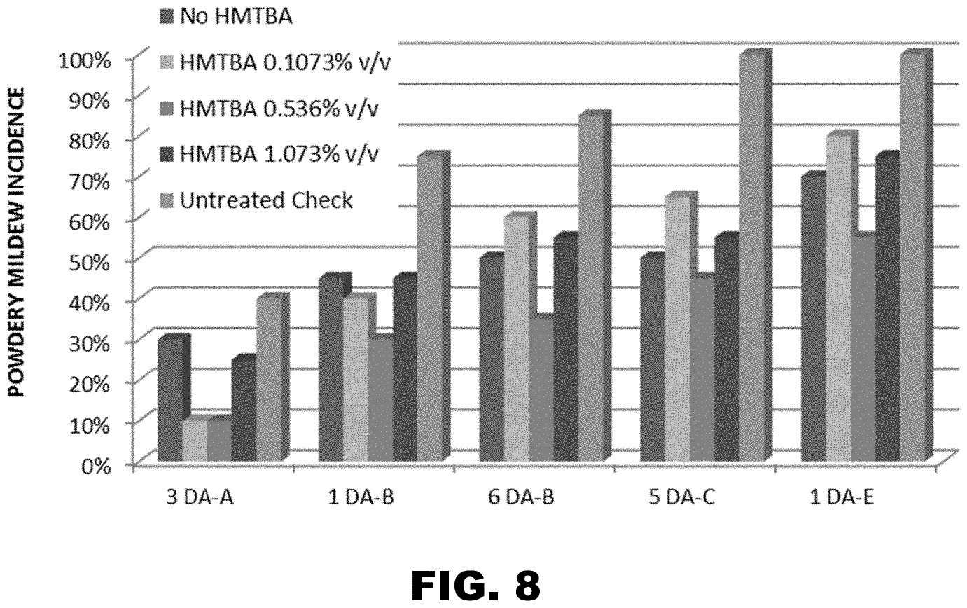

Table 10 and FIG. 7 present the average pest severity ratings at specific time points for each treatment group. Table 11 and FIG. 8 present the percent 5 of pest incidence, calculated from the severity ratings. These data show that mildew severity and incidence were significantly higher on the untreated plants at all rating intervals (approximately weekly). Up until six days after application B, HMTBA-treated plots had lower pest severity than plots treated with azoxystrobin alone. However, five days after application C, the azoxystrobin—alone treated plots had the same or lower severity than the low and high rate of HMTBA. HMTBA at 0.536% v/v had statistically lower pest severity ratings for all assessments compared to treated and untreated plants.

TABLE 10
Powdery Mildew Severity Score

| | | Average Pest Severity Score (0-10) | | | | |
|---|---|---|---|---|---|---|
| Trt. No. | Treatment Name | 3 DA-A | 1 DA-B | 6 DA-B | 5 DA-C | 1 DA-E |
| 1 | Azoxystrobin | 0.70 ab | 1.10 b | 1.30 b | 1.80 bc | 2.20 b |
| 2 | Azoxystrobin | 0.20 b | 0.90 b | 1.40 b | 2.10 b | 2.70 b |
| | HMTBA 0.1073% v/v | | | | | |
| 3 | Azoxystrobin | 0.20 b | 0.60 c | 0.90 c | 1.30 c | 1.60 c |
| | HMTBA 0.536% v/v | | | | | |
| 4 | Azoxystrobin | 0.70 a | 1.10 b | 1.30 b | 2.00 b | 2.30 b |
| | HMTBA 1.073% v/v | | | | | |
| 5 | Untreated Check | 1.00 a | 1.90 a | 2.20 a | 3.50 a | 3.50 a |

TABLE 11
Powdery Mildew Incidence.

Disease Incidence (%)

| Trt No. | Treatment Name | 3 DA-A | 1 DA-B | 6 DA-B | 5 DA-C | 1 DA-E |
|---|---|---|---|---|---|---|
| 1 | Azoxystrobin | 30.0% ab | 45.0% b | 50.0% bc | 50.0% c | 70.0% b |
| 2 | Azoxystrobin | 10.0% b | 40.0% b | 60.0% b | 65.0% b | 80.0% b |
| | HMTBA 0.1073% v/v | | | | | |
| 3 | Azoxystrobin | 10.0% b | 30.0% b | 35.0% c | 45.0% c | 55.0% c |
| | HMTBA 0.536% v/v | | | | | |
| 4 | Azoxystrobin | 25.0% ab | 45.0% b | 55.0% b | 55.0% bc | 75.0% b |
| | HMTBA 1.073% v/v | | | | | |
| 5 | Untreated Check | 40.0% a | 75.0% a | 85.0% a | 100.0% a | 100.0% a |

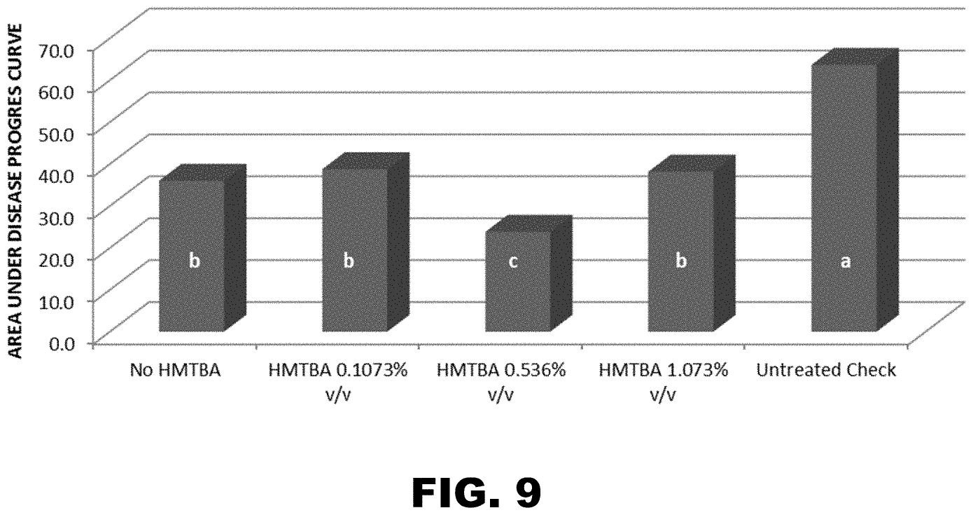

Table 12 and FIG. 9 present Area Under the Disease Progress Curve (AUDPC) for powdery mildew symptoms collected from five assessments.

TABLE 12
Powdery Mildew Area Under the Disease
Progress Curve (AUDPC).

| Trt. | | |
|---|---|---|
| No. | Treatment Name | AUDPC |
| 1 | Azoxystrobin | 36.00 b |
| 2 | Azoxystrobin | 68.75 b |
| | HMTBA 0.1073% v/v | |
| 3 | Azoxystrobin | 23.80 c |
| | HMTBA 0.536% v/v | |
| 4 | Azoxystrobin | 38.15 b |
| | HMTBA 1.073% v/v | |
| 5 | Untreated Check | 63.63 a |

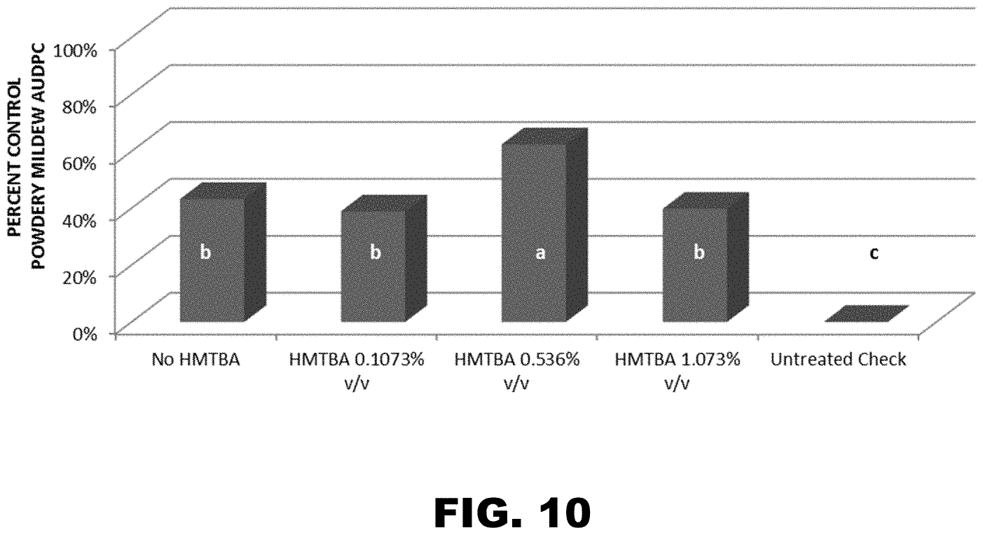

Table 13 and FIG. 10 show the percent disease control, which was calculated from AUDPC of severity using the Abbott's formula, to show disease control in treated plots compared to the untreated check.

TABLE 13
Powdery Mildew Percent Control.

| Trt. | | PM AUDPC |
|---|---|---|
| No. | Treatment Name | % Control |
| 1 | Azoxystrobin | 43.20% b |
| 2 | Azoxystrobin | 38.86% b |
| | HMTBA 0.1073% v/v | |
| 3 | Azoxystrobin | 62.41% a |
| | HMTBA 0.536% v/v | |
| 4 | Azoxystrobin | 39.79% b |
| | HMTBA 1.073% v/v | |
| 5 | Untreated Check | 0.00% c |

What is claimed is:

1. A composition comprising a fungicide and an adjuvant chosen from a compound of Formula (I) or salt thereof, a compound of Formula (II), or a polymer comprising repeat units of Formula (III): 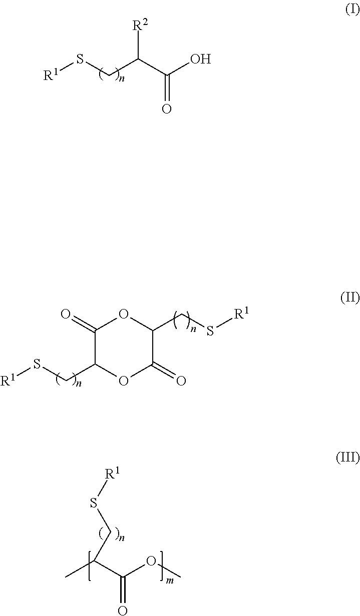
wherein:
R¹ is methyl or ethyl;
R² is hydroxyl or amino;
n is an integer of 1 or 2; and
m is an integer greater than 1;
wherein the adjuvant is present in an amount of less than 5% by weight of the composition.

2. The composition of claim 1, wherein R¹ is hydroxyl, R² is methyl, and n is 2.

3. The composition of claim 1, wherein the polymer comprising repeat units of Formula (III) has an average molecular weight of at least 500 Da.

4. The composition of claim 3, wherein the average molecular weight is at least 2000 Da.

5. The composition of claim 1, wherein the polymer comprising repeat units of Formula (III) further comprises a second type of repeat unit derived from a lactide, lactone, lactam, hydroxyalkanoate, or hydroxy ester.

6. The composition of claim 1, wherein the amount of adjuvant present in the composition is less than 2.5% by weight.

7. The composition of claim 6, wherein the amount of adjuvant present in the composition is less than 1.5% by weight.

8. The composition of claim 1, wherein the fungicide is a strobin.

9. The composition of claim 8, wherein the strobin is azoxystrobin, coumoxystrobin, dimoxystrobin, enoxastrobin, fenaminstrobin, flufenoxystrobin, fluoxastrobin, mandestrobin, metominstrobin, orysastrobin, picoxystrobin, pyraclostrobin, pyrametostrobin, pryaoxystrobin, pyriminostrobin, trifloxystrobin, or a mixture thereof.

10. The composition of claim 8, wherein the strobin is azoxystrobin.

11. The composition of claim 1, wherein the fungicide is captan, metconazole, or a mixture thereof.

12. The composition of claim 1, wherein the fungicide is a chitosan having an average molecular weight of about 16 kDa or less.

13. The composition of claim 1, wherein the fungicide is present in the composition in an amount of less than about 0.1% by weight.

14. The composition of claim 13, wherein the amount of the fungicide present in the composition is less than about 0.01% by weight.

15. The composition of claim 14, wherein the amount of the fungicide present in the composition is less than about 0.001% by weight.

16. The composition of claim 1, wherein the composition is formulated as an aqueous solution.

17. The composition of claim 1, wherein the composition is formulated as a dry powder or dust.

18. A method of treating or preventing a fungal infection, the method comprising applying a composition to a plant, a seed, or soil adjacent to the plant or the seed after planting, wherein the composition comprises a fungicide and an adjuvant chosen from a compound of Formula (I) or salt thereof, a compound of Formula (II), or a polymer comprising repeat units of Formula (III): 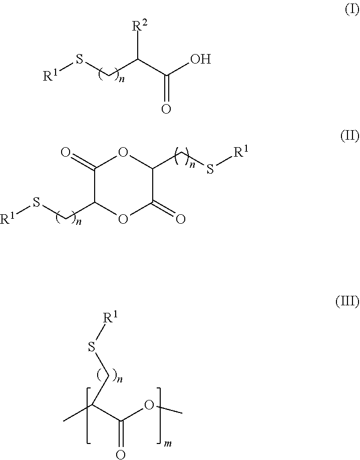
wherein:
R¹ is methyl or ethyl;
R² is hydroxyl or amino;
n is an integer of 1 or 2; and
m is an integer greater than 1;
wherein the adjuvant is present in an amount of less than 5% by weight of the composition.

19. The method of claim 18, wherein the fungal infection is Aspergillus, Fusarium, Phytophthora, Monilinia, Botrytis, Penicillium, Podosphaera, Rhizoctonia, Verticillium, or combinations thereof.

20. The method of claim 18, wherein the composition is formulated as an aqueous solution and is applied by spraying the plant, the seed, or the soil with the composition.

21. The method of claim 18, wherein the composition is formulated as a dry powder or dust and is applied by dusting the plant, the seed, or the soil with the composition.

22. The method of claim 18, wherein the plant or the seed is a food crop plant, a livestock crop plant, a vegetable plant, a fruit plant or free, or a landscaping plant or tree.

23. The method of claim 18, wherein the composition results in increased antifungal activity as compared to application of the fungicide alone.

24. The method of claim 23, wherein increased antifungal activity is manifested as disease control that is at least 20% higher than application of the fungicide alone as calculated by the Area Under the Disease Progress Curve.
